(19) United States
(12) Patent Application Publication
(10) Pub. No.: US 2013/0265660 A1
(43) Pub. Date: Oct. 10, 2013

(54) LENS UNIT AND IMAGING APPARATUS

(71) Applicant: SONY CORPORATION, TOKYO (JP)

(72) Inventors: Kyosuke Yoshida, Kanagawa (JP); Satoshi Imai, Kanagawa (JP); Masanori Hayashi, Tokyo (JP)

(73) Assignee: SONY CORPORATION, TOKYO (JP)

(21) Appl. No.: 13/855,077

(22) Filed: Apr. 2, 2013

(30) Foreign Application Priority Data
Apr. 9, 2012 (JP) 2012-088754

(51) Int. Cl. G02B 7/02

(52) U.S. Cl. CPC G02B 7/021
USPC 359/811; 425/468

(57) ABSTRACT

According to an illustrative embodiment, a lens unit is provided. The lens unit includes at least one lens having an engagement portion in a flange portion of the lens, the engagement portion having a width perpendicular or substantially perpendicular to the optical axis of the lens, and the width of the engagement portion decreasing as the engagement portion is traversed in a direction parallel or substantially parallel to the optical axis of the lens.

### CROSS-REFERENCE TO RELATE APPLICATION

The present application claims priority from Japanese Patent Application P2012-088754, filed in the Japanese Patent Office on Apr. 9, 2012, the entire content of which is hereby incorporated by reference herein.

### BACKGROUND

The present technology relates to a lens unit and an imaging apparatus and more particularly to a technology for improving the accuracy of positioning of lenses arranged adjacent to each other along their optical axes by forming a positioning projection on a flange portion of one of the adjacent lenses, forming a positioning recess on a flange portion of the other lens, and engaging the positioning projection into the positioning recess.

Known in the related art is an imaging apparatus such as a mobile phone with camera and a digital still camera, using a solid-state imaging device such as a CCD (Charge Coupled Device) and a CMOS (Complementary Metal Oxide Semiconductor).

Such an imaging apparatus is provided with a lens unit including a plurality of lenses and various optical lens components. The imaging apparatus is highly required to have a small size and the lens unit mounted therein is also required to have a small size and a short entire length.

Further, in a small-sized imaging apparatus such as a mobile phone with camera, the number of pixels in an imaging device has been increased more and more in recent years and there has become widespread such a type of imaging apparatus as including an imaging device with a large number of pixels similar to that of a digital still camera. Accordingly, any lens mounted in the imaging apparatus is required to have a high optical performance responding to the large number of pixels in the imaging device. To meet such a requirement, it is necessary to assemble a plurality of lenses with high accuracy and make the optical axes of these lenses coincide with each other with high accuracy.

Various methods of positioning lenses have been examined in the related art to assemble the lenses with high accuracy.

For example, known is a method of positioning lenses by forcing the lenses into a lens holder to thereby make the contact between the inner circumferential surface of the lens holder and the outer circumferential surface of each lens.

In this method, however, the lenses are positioned by the contact with the inner circumferential surface of the lens holder, so that the position of the optical axis of each lens depends upon the accuracy of processing of the lens holder. Accordingly, variations (tolerances) between parts other than the lenses have an influence upon the positioning accuracy of the lens.

To cope with this problem, there has been proposed a method of positioning lenses by making the contact between the inner circumferential surface of an annular projection formed on a flange portion of one of the lenses and the outer circumferential surface of an annular projection formed on a flange portion of the other lens (see Japanese Patent Laid-open No. 2002-196211, referred to as Patent Document 1 hereinafter, for example).

### SUMMARY

However, the method described in Patent Document 1 has a possibility that when at least one of a lens a and a lens b shown in FIG. 24 has processing variations (tolerances), a clearance may be generated between a projection c of the lens a and a projection d of the lens b.

This clearance causes a deviation between the optical axis of the lens a and the optical axis of the lens b, so that a good positioning accuracy cannot be ensured between the lens a and the lens b.

Further, when a force is not uniformly applied to the lens a or the lens b, but a large force F is applied to the outer circumferential portion of the lens a or the lens b as shown in FIG. 25, depending upon the accuracy of assembling of the lens a and the lens b, there is a possibility that the lens a or the lens b may be inclined in the direction shown by an arrow R about a contact point e between the projection c and the projection d as a fulcrum. Accordingly, the optical axis of the lens a or the lens b is inclined and a good positioning accuracy cannot therefore be ensured between the lens a and the lens b.

It is therefore desirable to improve the positioning accuracy between the lenses in a lens unit and an imaging apparatus.

In the lens unit and the imaging apparatus according to embodiments of the present technology, the positioning accuracy of the adjacent lenses can be improved.

According to an illustrative embodiment, a lens unit includes at least one lens having an engagement portion in a flange portion of the lens, the engagement portion having a width perpendicular or substantially perpendicular to the optical axis of the lens, and the width of the engagement portion decreasing as the engagement portion is traversed in a direction parallel or substantially parallel to the optical axis of the lens.

Other features and advantages of the present technology will become apparent from the following description taken in connection with the accompanying drawings.

### BRIEF DESCRIPTION OF THE DRAWINGS

FIG. 1 is a perspective view of an imaging apparatus according to an embodiment of the present technology;

FIG. 2 is an enlarged sectional view of a lens unit having two lenses included in the imaging apparatus shown in FIG. 1;

FIG. 3 is an enlarged exploded perspective view of the two lenses shown in FIG. 2;

FIG. 4 is another enlarged exploded perspective view of the two lenses shown in FIG. 2, showing a condition as viewed in a different direction from FIG. 3;

FIG. 5 is an enlarged sectional view of one of the two lenses;

FIG. 6 is an enlarged sectional view of the other lens;

FIG. 7 is an enlarged sectional view showing a condition where the lens shown in FIG. 5 is molded;

FIG. 8 is an enlarged sectional view showing a condition where the lens shown in FIG. 6 is molded;

FIG. 9 is an enlarged sectional view showing a positioning engagement portion having a triangular cross section;

FIG. 10 is an enlarged sectional view showing a positioning engagement portion having a U-shaped cross section;

FIG. 11 is an enlarged sectional view showing a positioning engagement portion having a cross section forming a free-form surface;

FIG. 12 is an enlarged sectional view showing the combination of a positioning projection and a positioning recess having different shapes;

FIG. 13 is an enlarged perspective view showing a lens having a plurality of positioning projections formed at intervals in the circumferential direction of the lens;

FIG. 14 is an enlarged perspective view showing a lens having an arcuate positioning projection;

FIG. 15 is an enlarged perspective view showing a lens having a plurality of positioning recesses formed at intervals in the circumferential direction of the lens;

FIG. 16 is an enlarged perspective view showing a lens having an arcuate positioning recess;

FIG. 17 is an enlarged sectional view of a lens unit having three lenses;

FIG. 18 is an exploded enlarged sectional view of the three lenses shown in FIG. 17;

FIG. 19 is an enlarged sectional view showing a condition where a central one of the three lenses shown in FIG. 17 is molded wherein a positioning recess is formed on one side and a positioning projection is formed on the other side;

FIG. 20 is an enlarged sectional view showing a modification of the central lens wherein positioning recesses are formed on both sides of the lens;

FIG. 21 is an enlarged sectional view showing another modification of the central lens wherein positioning projections are formed on both sides of the lens;

FIG. 22 is an enlarged sectional view showing a condition where the central lens wherein positioning recesses are formed respectively on both sides of the flange portion shown in FIG. 20 is molded;

FIG. 23 is an enlarged sectional view showing a condition where the central lens wherein positioning projections are formed respectively on both sides of the flange portion shown in FIG. 21 is molded;

FIG. 24 is an enlarged sectional view illustrating a problem in positioning of lenses in the related art; and

FIG. 25 is an enlarged sectional view illustrating another problem in positioning of the lenses in the related art.

### DETAILED DESCRIPTION OF THE PREFERRED EMBODIMENTS

Embodiments of the present technology will now be described with reference to the attached drawings.

In the following embodiments, the imaging apparatus of the present technology is applied to a mobile phone with camera, and the lens unit of the present technology is applied to a lens unit provided in the mobile phone with camera.

The applicability of the present technology is not limited to such a mobile phone with camera and a lens unit provided in this mobile phone with camera, but the present technology is widely applicable to various imaging apparatuses to be installed in a still camera, video camera, and any other equipment, and applicable also to lens units provided in these imaging apparatuses.

In the following description, the terms of front, back, upper, lower, right, and left will be used in the direction as viewed from an operator of the camera of a mobile phone in taking a picture. Accordingly, the front side means an object side and the back side means an operator side, i.e., an image side.

However, the terms of front, back, upper, lower, right, and left in the following description are merely used for the convenience of illustration and the present technology is not limited by these terms relating to directions in embodying the present technology.

### [Configuration of the Imaging Apparatus]

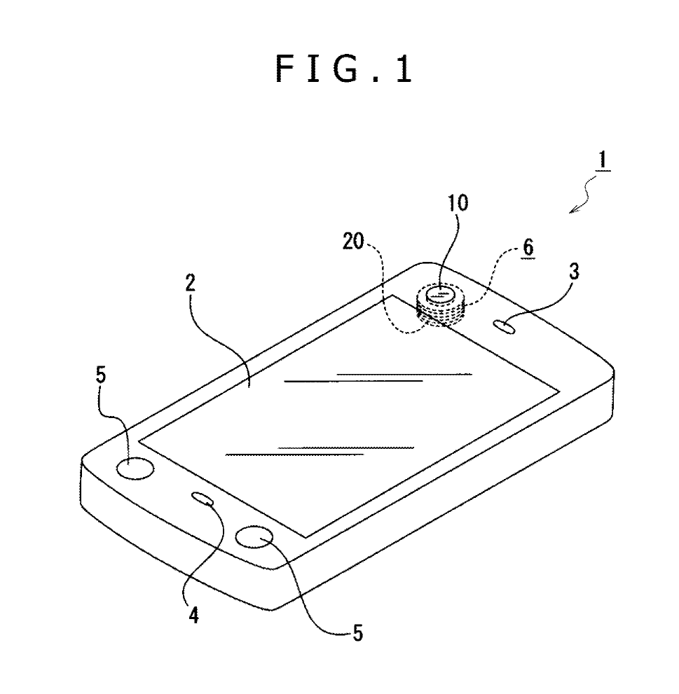

Referring to FIG. 1, there is shown an imaging apparatus (mobile phone) 1. The imaging apparatus 1 has a display panel 2, speaker 3, microphone 4, and operation keys 5 on one side.

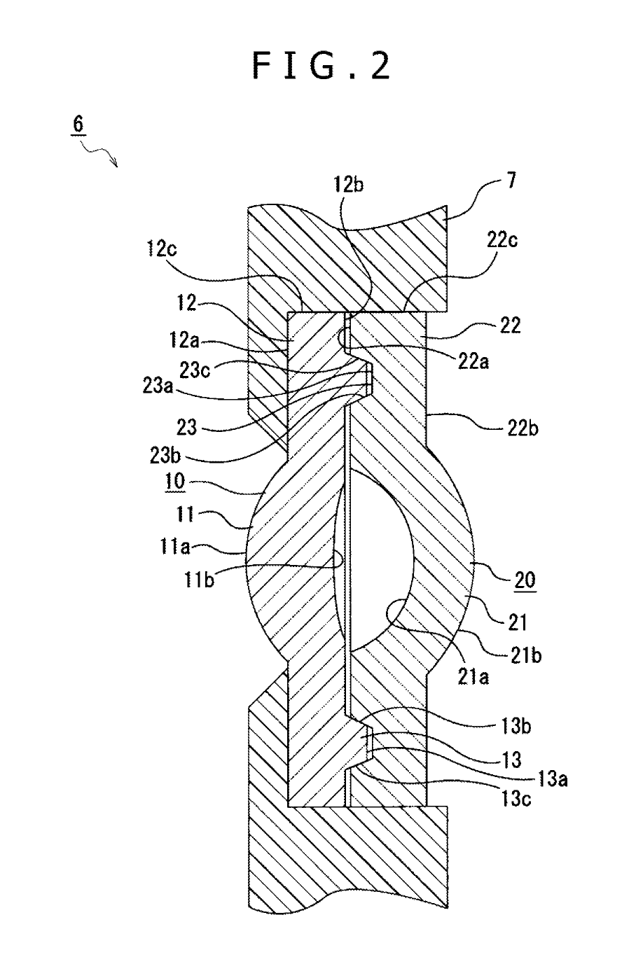

A lens unit 6 is incorporated in the imaging apparatus 1. As shown in FIG. 2, the lens unit 6 includes a lens holder 7, a lens 10 and a lens 20 held by the lens holder 7. Although not shown, an imaging device such as a CCD (Charge Coupled Device) and a CMOS (Complementary Metal Oxide Semiconductor) is arranged on the back side of the lens unit 6. The front surface of the imaging device is formed as an imaging surface.

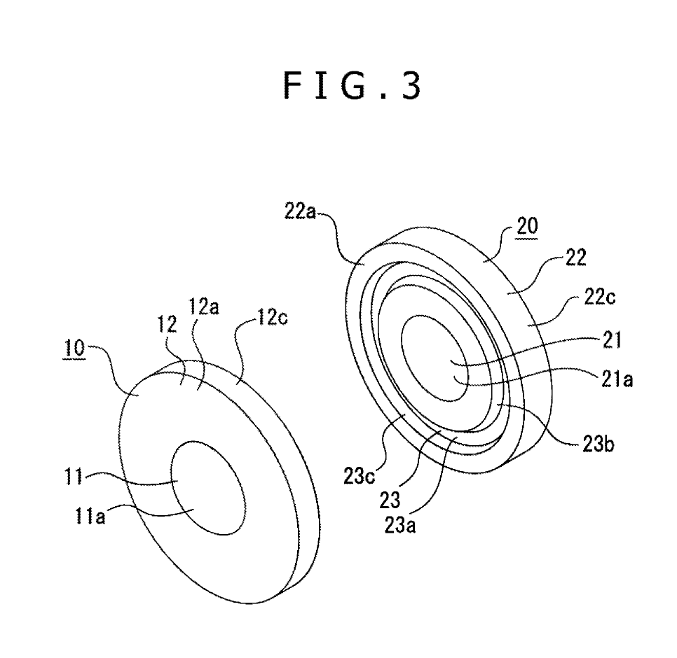

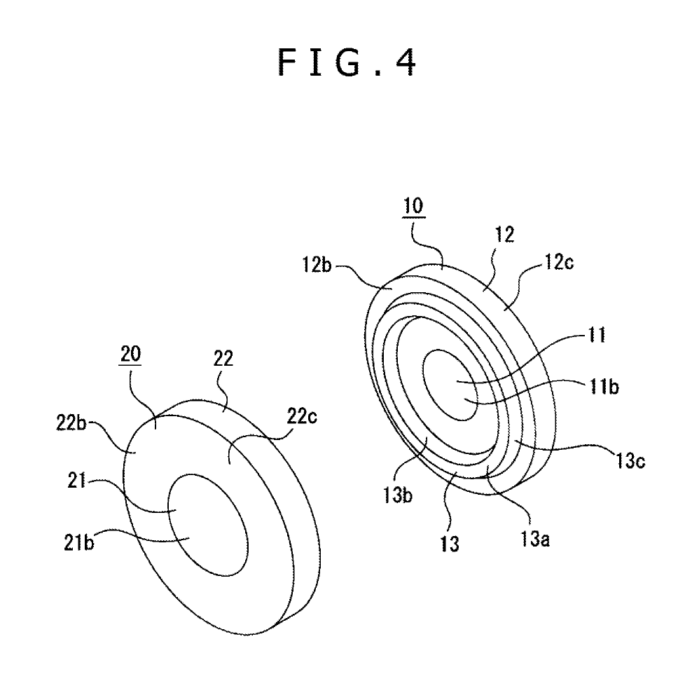

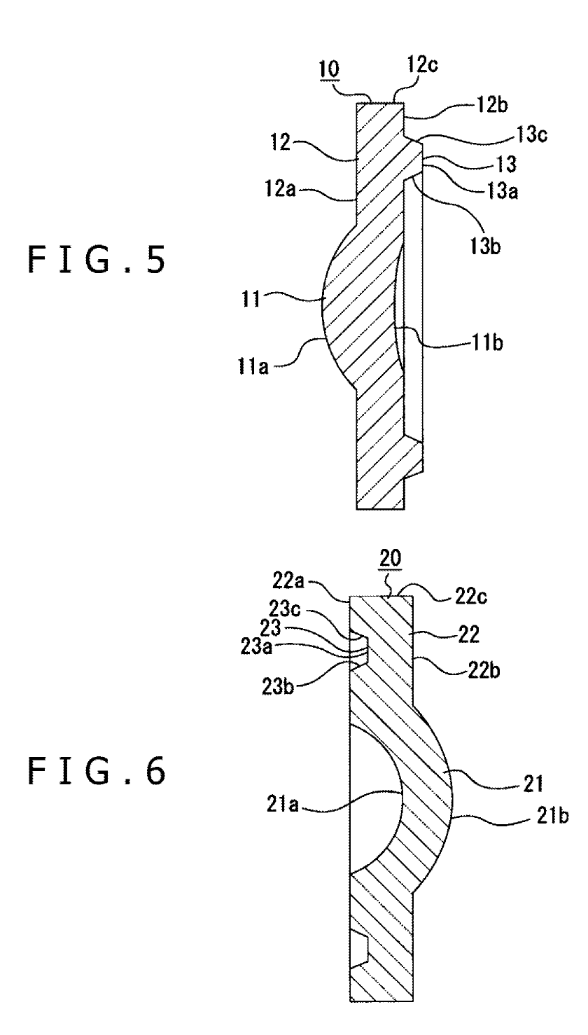

The lens unit 6 essentially includes at least two lenses, i.e., a plurality of lenses, wherein the number of lenses is arbitrary. There will now be described a configuration such that the lens unit 6 includes two lenses, i.e., the lens 10 and the lens 20 with reference to FIGS. 2 to 6.

The lens 10 is a meniscus lens convex on the object side, and it is formed of a resin material or a glass material. The lens 10 has an optical lens portion 11 and a flange portion 12. The flange portion 12 is formed with a positioning projection 13. The lens 10 may be selected from various lenses such as a meniscus lens convex on the image side, meniscus lens concave on the image side or the object side, biconvex lens, biconcave lens, plano-convex lens, and plano-concave lens.

The optical lens portion 11 is a central portion of the lens 10 and has a function of transmitting an incident effective light flux toward the imaging surface. The optical lens portion 11 has an optical surface 11a formed on the object side and an optical surface 11b formed on the image side. For example, the optical surface 11a is a convex surface and the optical surface 11b is a concave surface.

The flange portion 12 is so formed as to continue to the outer circumference of the optical lens portion 11. The flange portion 12 has an annular shape, and the surface of the flange portion 12 is composed of a first surface 12a oriented to the object side, a second surface 12b oriented to the image side, and an outer circumferential surface 12c.

The positioning projection 13 projects toward the image side and has an annular shape about the optical axis. The sectional shape of the positioning projection 13 along the optical axis is a trapezoidal shape such that the width is decreased with an increase in height in the axial direction. The positioning projection 13 is formed as a positioning engagement portion to be engaged with a positioning recess of the lens 20 as hereinafter described.

The surface of the positioning projection 13 is composed of a base surface 13a oriented to the image side, an inner side surface 13b continuing to the inner circumference of the base surface 13a, and an outer side surface 13c continuing to the outer circumference of the base surface 13a. The inner side surface 13b is inclined so as to be displaced more radially inside with an increase in distance from the base surface 13a, whereas the outer side surface 13c is inclined so as to be displaced more radially outside with an increase in distance from the base surface 13a.

The lens 20 is a meniscus lens convex on the image side, and it is formed of a resin material or a glass material. The lens 20 has an optical lens portion 21 and a flange portion 22. The flange portion 22 is formed with a positioning recess 23. The lens 20 may be selected from various lenses such as a meniscus lens convex on the object side, meniscus lens concave on the image side or the object side, biconvex lens, biconcave lens, plano-convex lens, and plano-concave lens.

The optical lens portion 21 is a central portion of the lens 20 and has a function of transmitting an incident effective light flux toward the imaging surface. The optical lens portion 21 has an optical surface 21a formed on the object side and an optical surface 21b formed on the image side. For example, the optical surface 21a is a concave surface and the optical surface 21b is a convex surface.

The flange portion 22 is so formed as to continue to the outer circumference of the optical lens portion 21. The flange portion 22 has an annular shape, and the surface of the flange portion 22 is composed of a first surface 22a oriented to the object side, a second surface 22b oriented to the image side, and an outer circumferential surface 22c connecting the first surface 22a and the second surface 22b.

The positioning recess 23 opens to the object side and has an annular shape about the optical axis. The sectional shape of the positioning recess 23 along the optical axis is a trapezoidal shape such that the width is increased with a decrease in depth in the axial direction. The positioning recess 23 is formed as a positioning engagement portion to be engaged with the positioning projection 13 of the lens 10.

The surface of the positioning recess 23 is composed of a bottom surface 23a oriented to the object side, an inner side surface 23b continuing to the inner circumference of the bottom surface 23a, and an outer side surface 23c continuing to the outer circumference of the bottom surface 23a. The inner side surface 23b is inclined so as to be displaced more radially inside with an increase in distance from the bottom surface 23a, whereas the outer side surface 23c is inclined so as to be displaced more radially outside with an increase in distance from the bottom surface 23a.

### [Molding of the Lenses]

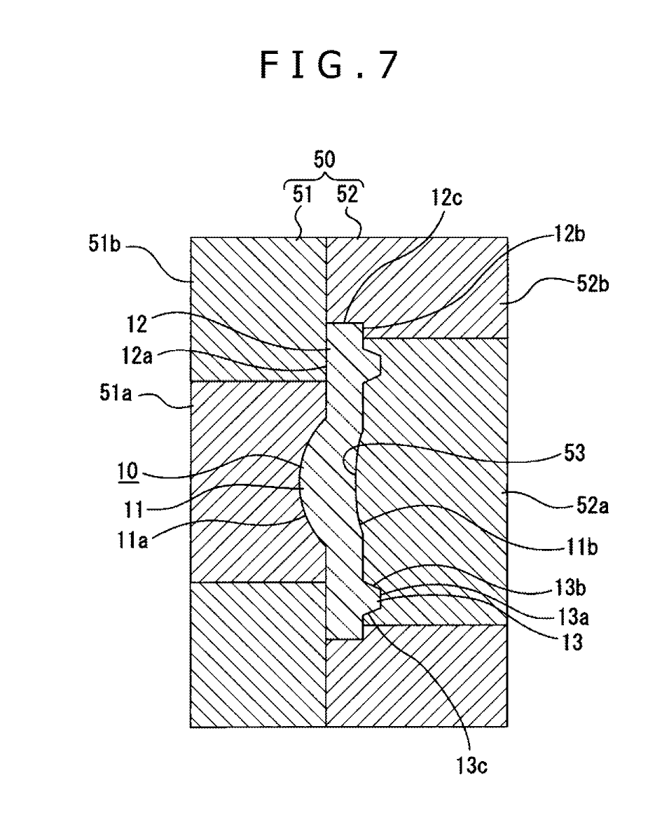

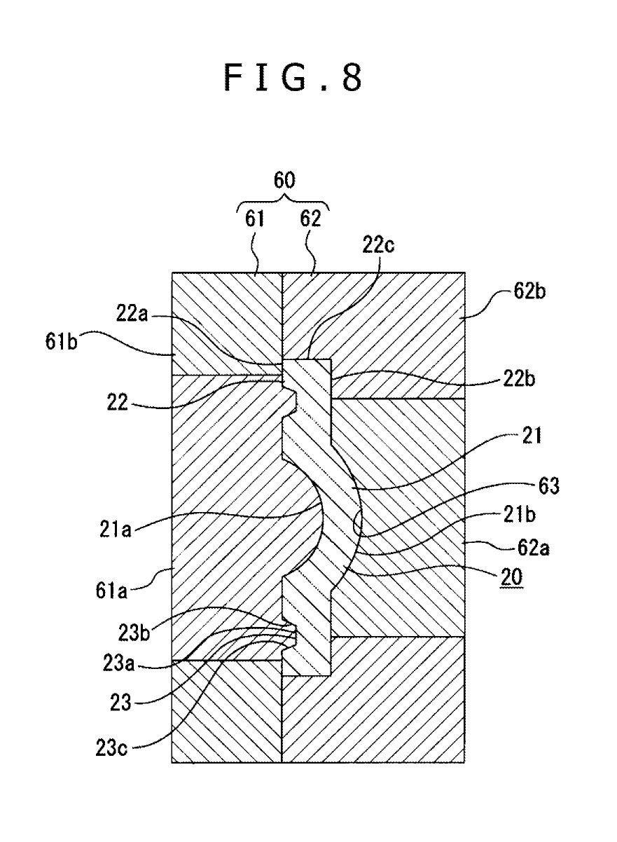

Molding of the lenses 10 and 20 will now be described with reference to FIGS. 7 and 8.

As shown in FIG. 7, the lens 10 is molded by using a mold 50. The mold 50 is composed of a first mold 51 and a second mold 52.

The first mold 51 has a central mold 51a located centrally and a peripheral mold 51b located around the periphery of the central mold 51a. Similarly, the second mold 52 has a central mold 52a located centrally and a peripheral mold 52b located around the periphery of the central mold 52a.

The lens 10 is molded by filling a lens material into a cavity 53 defined by matching the first mold 51 and the second mold 52. Of the object-side surface of the lens 10, the optical surface 11a and an inner circumferential portion of the first surface 12a are formed by the central mold 51a, and the remaining portion of the first surface 12a except the inner circumferential portion is formed by the peripheral mold 51b. Further, of the image-side surface of the lens 10 and the outer circumferential surface 12c, the optical surface 11b, a portion of the second surface 12b except its outer circumferential portion, and all the surfaces of the positioning projection 13 are formed by the central mold 52a, and the outer circumferential portion of the second surface 12b and the outer circumferential surface 12c are formed by the peripheral mold 52b. The outer circumferential surface 12c may be formed by the peripheral mold 51b or by both the peripheral mold 51b and the peripheral mold 52b.

Accordingly, the optical surface 11b and all the surfaces of the positioning projection 13 of the lens 10 are formed by the central mold 52a, i.e., by the same mold.

As shown in FIG. 8, the lens 20 is molded by using a mold 60. The mold 60 is composed of a first mold 61 and a second mold 62.

The first mold 61 has a central mold 61a located centrally and a peripheral mold 61b located around the periphery of the central mold 61a. Similarly, the second mold 62 has a central mold 62a located centrally and a peripheral mold 62b located around the periphery of the central mold 62a.

The lens 20 is molded by filling a lens material into a cavity 63 defined by matching the first mold 61 and the second mold 62. Of the object-side surface of the lens 20, the optical surface 21a, a portion of the first surface 22a except its outer circumferential portion, and all the surfaces of the positioning recess 23 are formed by the central mold 61a, and the outer circumferential portion of the first surface 22a is formed by the peripheral mold 61b. Further, of the image-side surface of the lens 20 and the outer circumferential surface 22c, the optical surface 21b and an inner circumferential portion of the second surface 22b are formed by the central mold 62a, and an outer circumferential portion of the second surface 22b and the outer circumferential surface 22c are formed by the peripheral mold 62b. The outer circumferential surface 22c may be formed by the peripheral mold 61b or by both the peripheral mold 61b and the peripheral mold 62b.

Accordingly, the optical surface 21a and all the surfaces of the positioning recess 23 of the lens 20 are formed by the central mold 61a, i.e., by the same mold.

### [Positioning of the Lenses]

As shown in FIG. 2, thus formed lens 10 and lens 20 are positioned by engaging the positioning projection 13 of the lens 10 into the positioning recess 23 of the lens 20.

In the condition where the lens 10 and the lens 20 are positioned, the inner side surface 13b of the positioning projection 13 is in contact with the inner side surface 23b of the positioning recess 23, and the outer side surface 13c of the positioning projection 13 is in contact with the outer side surface 23c of the positioning recess 23. Further, in this condition, the base surface 13a of the positioning projection 13 is in proximity to or in contact with the bottom surface 23a of the positioning recess 23, and the second surface 12b of the flange portion 12 is in proximity to or in contact with the first surface 22a of the flange portion 22.

The lens 10 and the lens 20 thus positioned is held by the lens holder 7 as shown in FIG. 2.

### [Other Embodiments of the Positioning Engagement Portion]

While the sectional shape of the positioning projection 13 and the positioning recess 23 is a trapezoidal shape in the above embodiment, the sectional shape of the positioning projection 13 and the positioning recess 23 is not limited to a trapezoidal shape, but any other suitable sectional shapes may be adopted as follows.

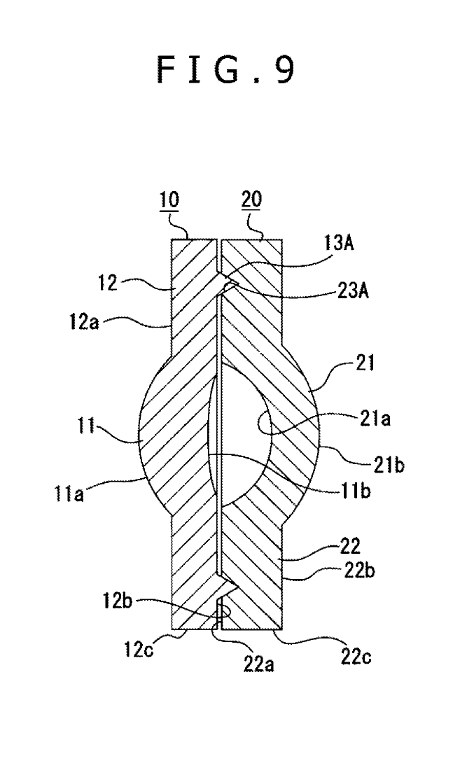

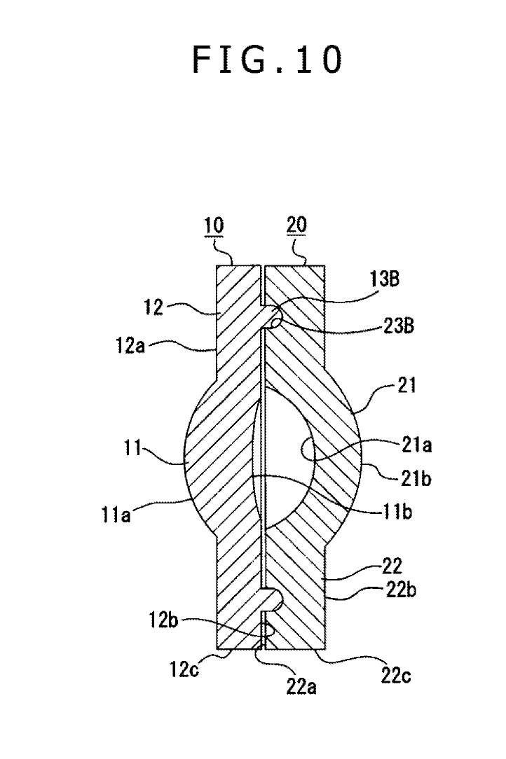

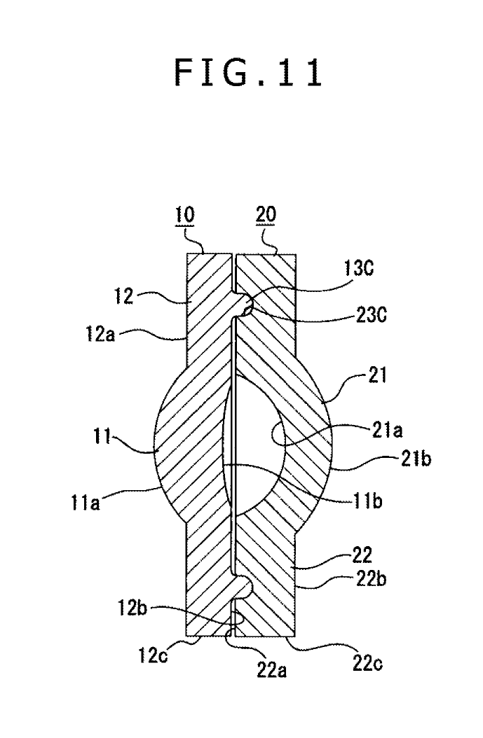

For example, as shown in FIG. 9, a positioning projection 13A and a positioning recess 23A each having a triangular cross section may be adopted. Further, as shown in FIG. 10, a positioning projection 13B and a positioning recess 23B each having a U-shaped cross section may also be adopted. Further, as shown in FIG. 11, a positioning projection 13C and a positioning recess 23C each having a cross section forming a free-form surface may also be adopted.

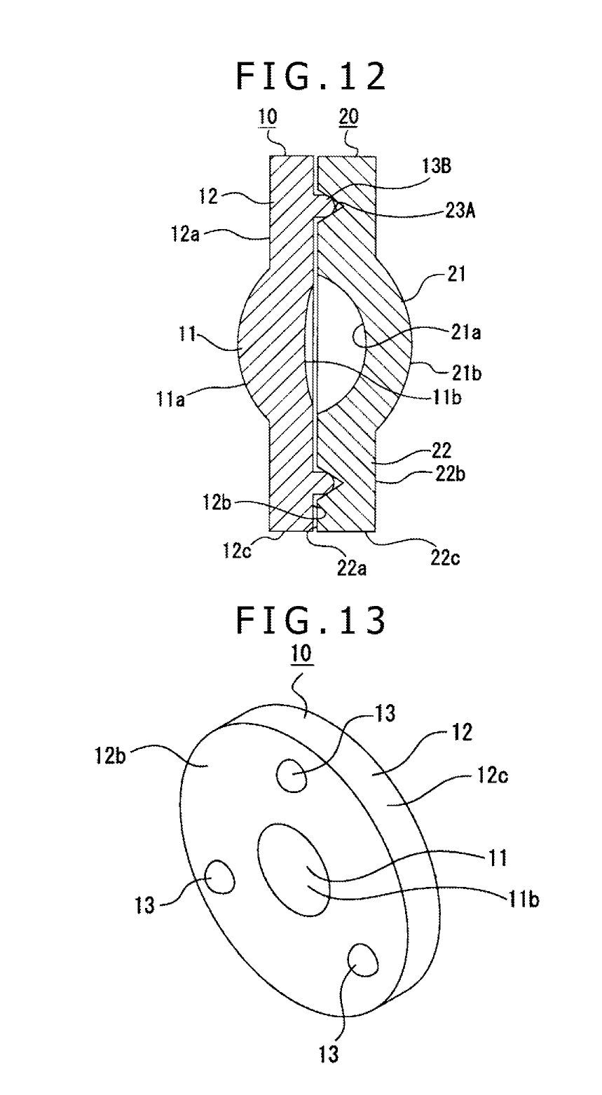

Further, as shown in FIG. 12, the positioning projection 13B having a U-shaped cross section and the positioning recess 23A having a triangular cross section may be combined. While a U-shaped cross section and a triangular cross section are combined as shown in FIG. 12 as an example for combining different shapes, various other different sectional shapes may be combined.

Further, while the positioning projection 13 (including the positioning projections 13A, 13B, and 13C, the same applying to the following) and the positioning recess 23 (including the positioning recesses 23A, 23B, and 23C, the same applying to the following) have an annular shape in the above embodiment, the shape of the positioning projection 13 and the positioning recess 23 is not limited to an annular shape.

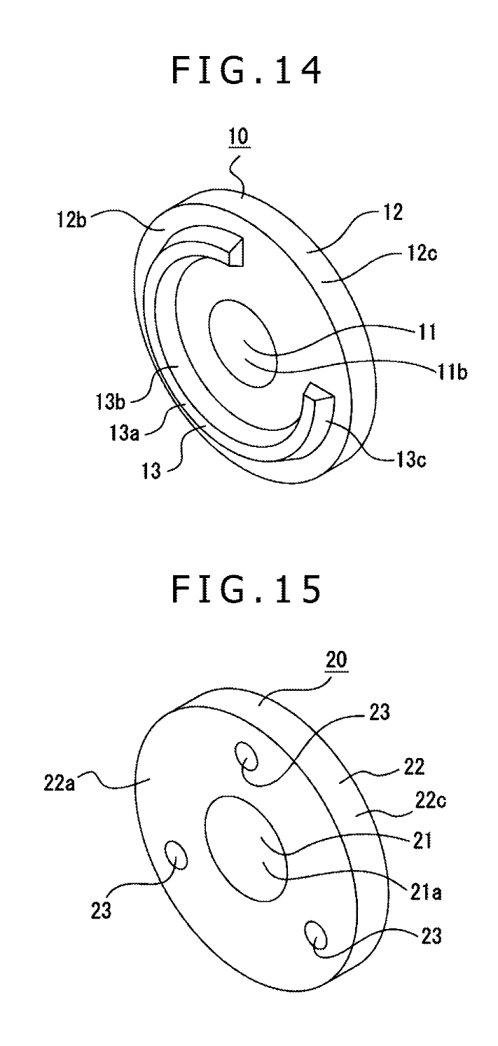

For example, as shown in FIG. 13, a plurality of positioning projections 13 may be formed at intervals in the circumferential direction. Further, as shown in FIG. 14, a positioning projection 13 having an arcuate shape may be formed.

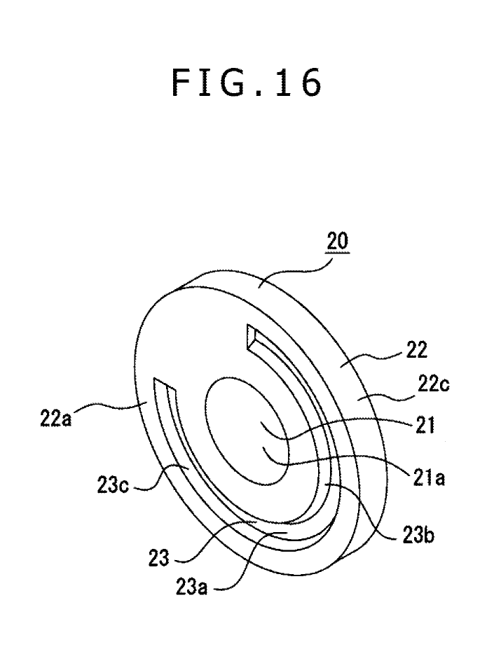

Similarly, as shown in FIG. 15, a plurality of positioning recesses 23 may be formed at intervals in the circumferential direction. Further, as shown in FIG. 16, a positioning recess 23 having an arcuate shape may be formed.

The plural positioning projections 13 formed at intervals in the circumferential direction may be engaged with the plural positioning recesses 23 formed at intervals in the circumferential direction or may be engaged with the positioning recess 23 having an annular shape. Further, the positioning projection 13 having an arcuate shape may be engaged with the positioning recess 23 having an arcuate shape or may be engaged with the positioning recess 23 having an annular shape.

In the case that the plural positioning projections 13 formed at intervals in the circumferential direction or the plural positioning recesses 23 formed at intervals in the circumferential direction are adopted, a part of the flange portion 12 or 22 not formed with the plural positioning projections 13 or the plural positioning recesses 23 may be used as a part where a gate for filling a resin in molding is located. Similarly, in the case that the positioning projection 13 having an arcuate shape or the positioning recess 23 having an arcuate shape is adopted, a part of the flange portion 12 or 22 not formed with the positioning projection 13 or the positioning recess 23 may be used as a part where the gate for filling a resin in molding is located.

With this configuration that a part of the flange portion 12 or 22 not formed with the positioning projection or projections 13 or the positioning recess or recesses 23 is used as a part where the gate is located, the area of the flange portion 12 or 22 can be reduced to thereby attain a reduction in size of the lens 10 or 20.

In the case that a light shielding sheet is provided between the flange portion 12 of the lens 10 and the flange portion 22 of the lens 20, the light shielding sheet is located in the area where the positioning projection 13 and the positioning recess 23 are not formed.

Accordingly, with the configuration that the plural positioning projections 13 or recesses 23 formed at intervals in the circumferential direction are adopted or the positioning projection 13 or recess 23 having an arcuate shape is adopted, the area of the light shielding sheet can be increased to thereby ensure high shieldability to light.

By increasing the area of the light shielding sheet as mentioned above, harmful light causing ghost or flare can be effectively shielded to thereby improve an optical performance.

While the lens 10 has the positioning projection 13 and the lens 20 has the positioning recess 23 in the above embodiment, the lens 10 may have a positioning recess and the lens 20 may have a positioning projection.

### [Summary 1]

As described above, the lens 10 and the lens 20 are positioned by the contact of the inner side surface 13b and the inner side surface 23b and the contact of the outer side surface 13c and the outer side surface 23c.

Accordingly, in the condition where the lens 10 and the lens 20 are positioned, there is no clearance between the positioning projection 13 and the positioning recess 23 formed as the positioning engagement portions, so that the positioning accuracy of the lens 10 and the lens 20 can be improved and the optical axis of the lens 10 and the optical axis of the lens 20 can therefore be made to coincide with each other with high accuracy.

Further, there is no possibility that one of the lenses 10 and 20 is inclined with respect to the other about a contact point between the positioning projection 13 and the positioning recess 23, thereby preventing the inclination of the optical axis. Accordingly, the positioning accuracy of the lens 10 and the lens 20 can be further improved.

In the case that the positioning projection 13 and the positioning recess 23 as the positioning engagement portions have an annular shape, the moldability of the lens 10 and the lens 20 can be improved and the workability can also be improved because alignment in the circumferential direction is not required in positioning the lens 10 and the lens 20. Further, in the case that the positioning engagement portions have an annular shape, the molds can be easily formed by the same processing, so that the processing accuracy of the molds can be improved to thereby improve the processing accuracy of the lenses 10 and 20. Accordingly, the positional accuracy of the optical lens portion 11 and the positioning projection 13 can be improved and the positional accuracy of the optical lens portion 21 and the positioning recess 23 can also be improved.

The sectional shape of the positioning projection 13 along the optical axis is a shape such that the width is decreased with an increase in height in the axial direction. Accordingly, the positioning projection 13 can be easily inserted into the positioning recess 23, thereby improving the workability in positioning the lenses 10 and 20.

The opening space of the positioning recess 23 along the optical axis is increased with a decrease in depth in the axial direction. Accordingly, the positioning projection 13 can be easily inserted into the positioning recess 23, thereby improving the workability in positioning the lenses 10 and 20.

In addition, the optical surface 11b and all the surfaces of the positioning projection 13 of the lens 10 are formed by the central mold 52a, i.e., by the same mold. Similarly, the optical surface 21a and all the surfaces of the positioning recess 23 of the lens 20 are formed by the central mold 61a, i.e., by the same mold.

Accordingly, the positional accuracy of the optical lens portion 11 and the positioning projection 13 in the lens 10 can be improved and the positional accuracy of the optical lens portion 21 and the positioning recess 23 in the lens 20 can also be improved, thereby improving the positioning accuracy of the lens 10 and the lens 20.

### [Positioning of Three Lenses]

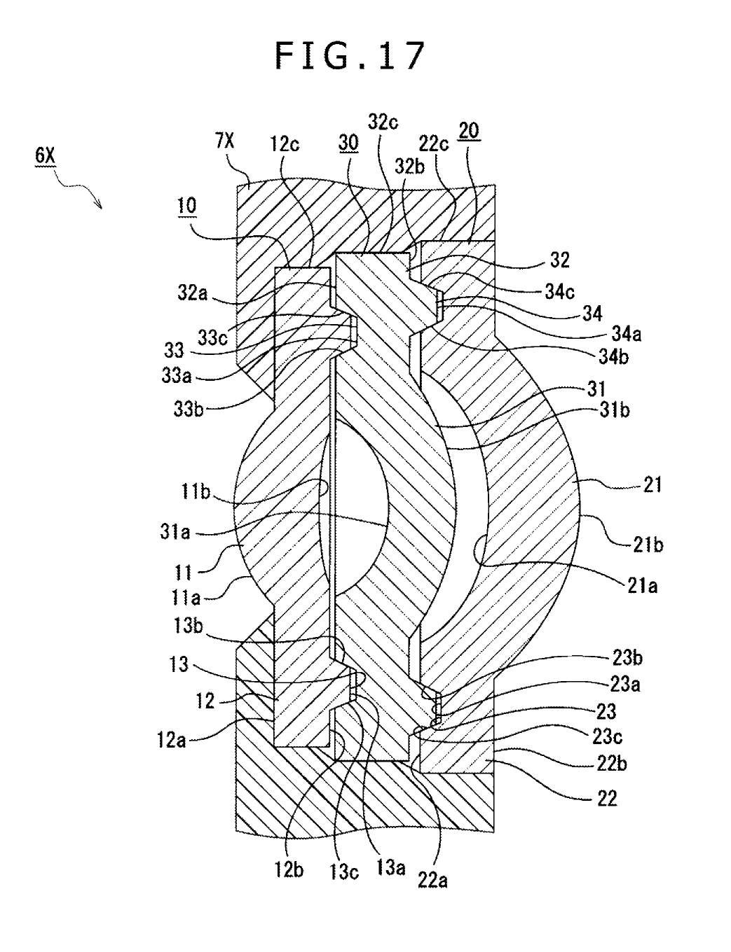

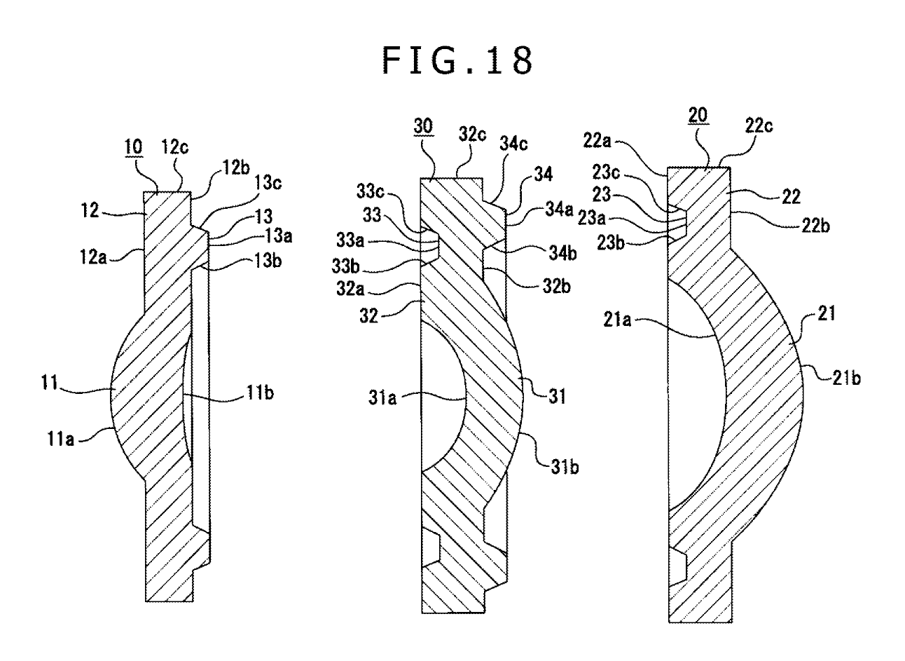

Another embodiment of the present technology will now be described with reference to FIGS. 17 to 19. In this embodiment, three lenses are positioned.

As shown in FIG. 17, a lens unit 6X is incorporated in the imaging apparatus 1. The lens unit 6X has a lens holder 7X, a lens 10, a lens 20 and a lens 30 held by the lens holder 7X. The lens 10 shown in FIG. 17 is similar to the lens 10 shown in FIG. 2, and the lens 20 shown in FIG. 17 is similar to the lens 20 shown in FIG. 2. The lens 30 is interposed between the lens 10 and the lens 20.

Although not shown, an imaging device such as a CCD and a CMOS is arranged on the back side of the lens unit 6X, and the front surface of the imaging device is formed as an imaging surface.

The lens 30 is a meniscus lens convex on the image side, and it is formed of a resin material or a glass material. As shown in FIG. 18, the lens 30 has an optical lens portion 31 and a flange portion 32. The flange portion is formed with a positioning recess 33 oriented to the object side and a positioning projection 34 oriented to the image side. The lens 30 may be selected from various lenses such as a meniscus lens convex on the object side, meniscus lens concave on the image side or the object side, biconvex lens, biconcave lens, plano-convex lens, and plano-concave lens.

The optical lens portion 31 is a central portion of the lens 30 and has a function of transmitting an incident effective light flux toward the imaging surface. The optical lens portion 31 has an optical surface 31a formed on the object side and an optical surface 31b formed on the image side. For example, the optical surface 31a is a concave surface and the optical surface 31b is a convex surface.

The flange portion 32 is so formed as to continue to the outer circumference of the optical lens portion 31. The flange portion 32 has an annular shape, and the surface of the flange portion 32 is composed of a first surface 32a oriented to the object side, a second surface 32b oriented to the image side, and an outer circumferential surface 32c.

The positioning recess 33 opens to the object side and has an annular shape about the optical axis. The sectional shape of the positioning recess 33 along the optical axis is a trapezoidal shape such that the width is increased with a decrease in depth in the axial direction. The positioning recess 33 is formed as a positioning engagement portion to be engaged with the positioning projection 13 of the lens 10.

The surface of the positioning recess 33 is composed of a bottom surface 33a oriented to the object side, an inner side surface 33b continuing to the inner circumference of the bottom surface 33a, and an outer side surface 33c continuing to the outer circumference of the bottom surface 33a. The inner side surface 33b is inclined so as to be displaced more radially inside with an increase in distance from the bottom surface 33a, whereas the outer side surface 33c is inclined so as to be displaced more radially outside with an increase in distance from the bottom surface 33a.

The positioning projection 34 projects toward the image side and has an annular shape about the optical axis. The sectional shape of the positioning projection 34 along the optical axis is a trapezoidal shape such that the width is decreased with an increase in height in the axial direction. The positioning projection 34 is formed as a positioning engagement portion to be engaged with the positioning recess 23 of the lens 20.

The surface of the positioning projection 34 is composed of a base surface 34a oriented to the image side, an inner side surface 34b continuing to the inner circumference of the base surface 34a, and an outer side surface 34c continuing to the outer circumference of the base surface 34a. The inner side surface 34b is inclined so as to be displaced more radially inside with an increase in distance from the base surface 34a, whereas the outer side surface 34c is inclined so as to be displaced more radially outside with an increase in distance from the base surface 34a.

### [Molding of the Lens]

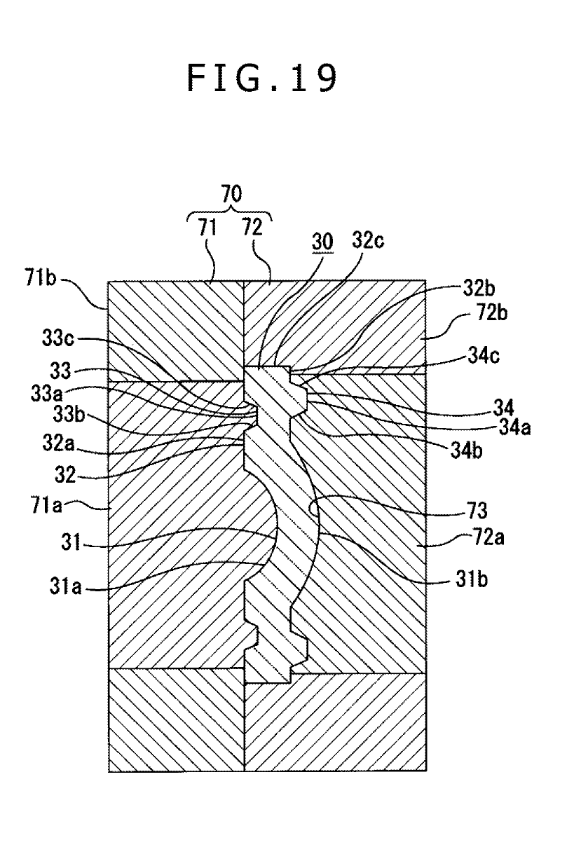

Molding of the lens 30 will now be described with reference to FIG. 19.

As shown in FIG. 19, the lens 30 is molded by using a mold 70. The mold 70 is composed of a first mold 71 and a second mold 72.

The first mold 71 has a central mold 71a located centrally and a peripheral mold 71b located around the periphery of the central mold 71a. Similarly, the second mold 72 has a central mold 72a located centrally and a peripheral mold 72b located around the periphery of the central mold 72a.

The lens 30 is molded by filling a lens material into a cavity 73 defined by matching the first mold 71 and the second mold 72. Of the object-side surface of the lens 30, the optical surface 31a, a portion of the first surface 32a except its outer circumferential portion, and all the surfaces of the positioning recess 33 are formed by the central mold 71a, and the outer circumferential portion of the first surface 32a is formed by the peripheral mold 71b. Further, of the image-side surface of the lens 30 and the outer circumferential surface 32c, the optical surface 31b, a portion of the second surface 32b except its outer circumferential portion, and all the surfaces of the positioning projection 34 are formed by the central mold 72a, and the outer circumferential portion of the second surface 32b and the outer circumferential surface 32c are formed by the peripheral mold 72b. The outer circumferential surface 32c may be formed by the peripheral mold 71b or by both the peripheral mold 71b and the peripheral mold 72b.

Accordingly, the optical surface 31a and all the surfaces of the positioning recess 33 are formed by the central mold 71a, i.e., by the same mold. Further, the optical surface 31b and all the surfaces of the positioning projection 34 are formed by the central mold 72a, i.e., by the same mold.

### [Positioning of the Lenses]

As shown in FIG. 17, the lens 10 and the lens 30 are positioned by engaging the positioning projection 13 of the lens 10 into the positioning recess 33 of the lens 30. Further, the lens 30 and the lens 20 are positioned by engaging the positioning projection 34 of the lens 30 into the positioning recess 23 of the lens 20. Accordingly, the lenses 10, 20, and 30 are positioned.

In the condition where the lens 10 and the lens 30 are positioned, the inner side surface 13b of the positioning projection 13 is in contact with the inner side surface 33b of the positioning recess 33, and the outer side surface 13c of the positioning projection 13 is in contact with the outer side surface 33c of the positioning recess 33. Further, in this condition, the base surface 13a of the positioning projection 13 is in proximity to or in contact with the bottom surface 33a of the positioning recess 33, and the second surface 12b of the flange portion 12 is in proximity to or in contact with the first surface 32a of the flange portion 32.

In the condition where the lens 30 and the lens 20 are positioned, the inner side surface 34b of the positioning projection 34 is in contact with the inner side surface 23b of the positioning recess 23, and the outer side surface 34c of the positioning projection 34 is in contact with the outer side surface 23c of the positioning recess 23. Further, in this condition, the base surface 34a of the positioning recess 34 is in proximity to or in contact with the bottom surface 23a of the positioning recess 23, and the second surface 32b of the flange portion 32 is in proximity to or in contact with the first surface 22a of the flange portion 22.

The lens 10, the lens 30, and the lens 20 thus positioned is held by the lens holder 7X as shown in FIG. 17.

While the positioning recess 33 is formed on the object-side surface of the lens 30 and the positioning projection 34 is formed on the image-side surface of the lens 30 in this embodiment, the positioning projection 34 may be formed on the object-side surface of the lens 30 and the positioning recess 33 may be formed on the image-side surface of the lens 30. In this case, a positioning recess is formed on the image-side surface of the lens 10 located on the object side of the lens 30 and a positioning projection is formed on the object-side surface of the lens 20 located on the image side of the lens 30.

By using the lens 30 having the positioning recess 33 formed on one of the object-side surface and the image-side surface of the flange portion 32 and having the positioning projection 34 formed on the other, the thickness of the flange portion 32 can be made substantially uniform in the radial direction.

Accordingly, by ensuring the uniformity of the thickness as mentioned above, it is difficult that the amount of molding sink becomes non-uniform in the radial direction. As a result, a stable molded condition of the lens 30 can be ensured to thereby improve the molding accuracy of the lens 30 and accordingly improve the positioning accuracy.

### [Other Embodiments of the Lens]

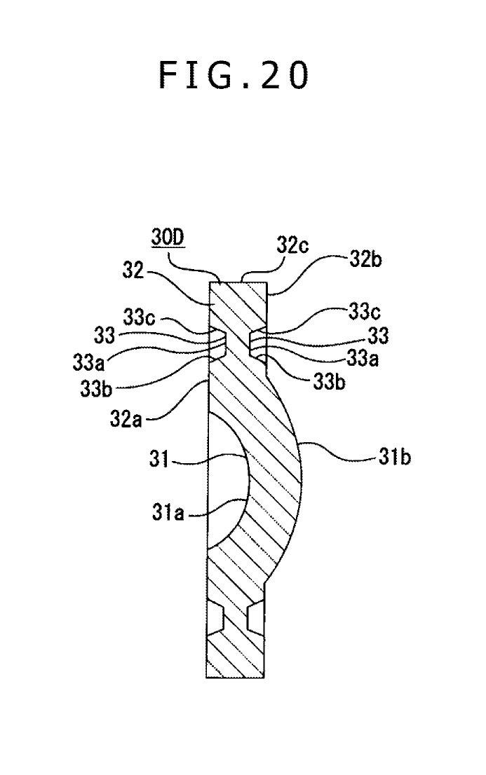

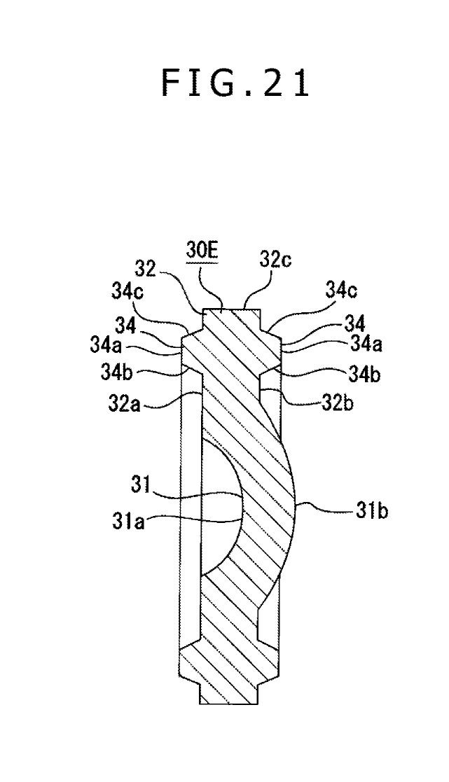

The lens 30 may be replaced by a lens 30D shown in FIG. 20 or a lens 30E shown in FIG. 21.

As shown in FIG. 20, the lens 30D has two positioning recesses 33 formed on the object-side surface and the image-side surface. In this case, a positioning projection is formed on the image-side surface of the lens 10 located on the object side of the lens 30D, and a positioning projection is formed on the object-side surface of the lens 20 located on the image side of the lens 30D.

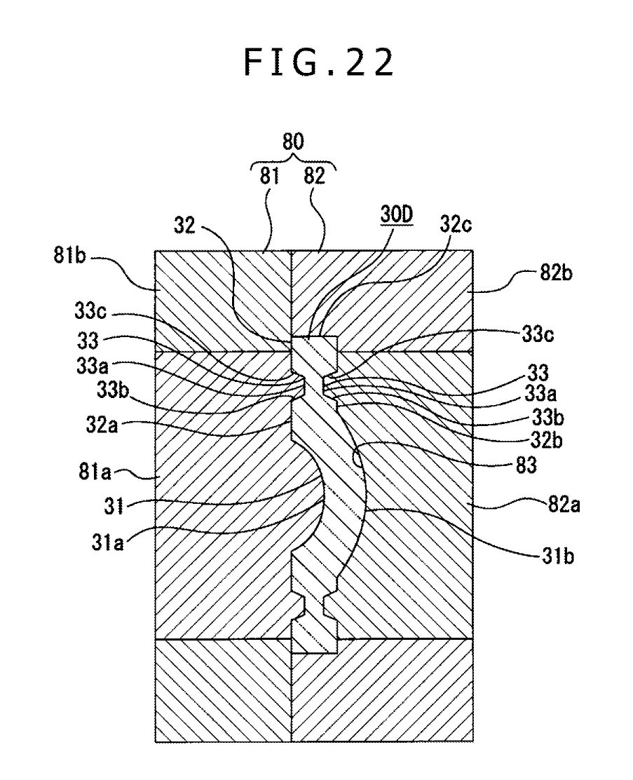

As shown in FIG. 22, the lens 30D is molded by using a mold 80. The mold 80 is composed of a first mold 81 and a second mold 82.

The first mold 81 has a central mold 81a located centrally and a peripheral mold 81b located around the periphery of the central mold 81a. Similarly, the second mold 82 has a central mold 82a located centrally and a peripheral mold 82b located around the periphery of the central mold 82a.

The lens 30D is molded by filling a lens material into a cavity 83 defined by matching the first mold 81 and the second mold 82. Of the object-side surface of the lens 30D, the optical surface 31a, a portion of the first surface 32a except its outer circumferential portion, and all the surfaces of the positioning recess 33 are formed by the central mold 81a, and the outer circumferential portion of the first surface 32a is formed by the peripheral mold 81b. Further, of the image-side surface of the lens 30D and the outer circumferential surface 32c, the optical surface 31b, a portion of the second surface 32b except its outer circumferential portion, and all the surfaces of the positioning recess 33 are formed by the central mold 82a, and the outer circumferential portion of the second surface 32b and the outer circumferential surface 32c are formed by the peripheral mold 82b. The outer circumferential surface 32c may be formed by the peripheral mold 81b or by both the peripheral mold 81b and the peripheral mold 82b.

Accordingly, the optical surface 31a and all the surfaces of the positioning recess 33 formed on the object side are formed by the central mold 81a, i.e., by the same mold. Further, the optical surface 31b and all the surfaces of the positioning recess 33 formed on the image side are formed by the central mold 82a, i.e., by the same mold.

As shown in FIG. 21, the lens 30E has two positioning projections 34 formed on the object-side surface and the image-side surface. In this case, a positioning recess is formed on the image-side surface of the lens 10 located on the object side of the lens 30E, and a positioning recess is formed on the object-side surface of the lens 20 located on the image side of the lens 30E.

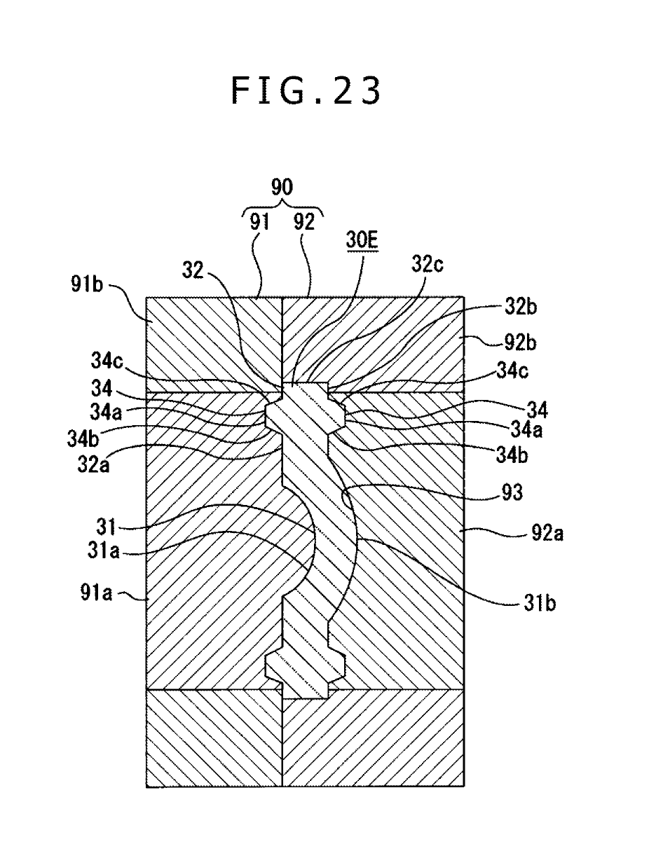

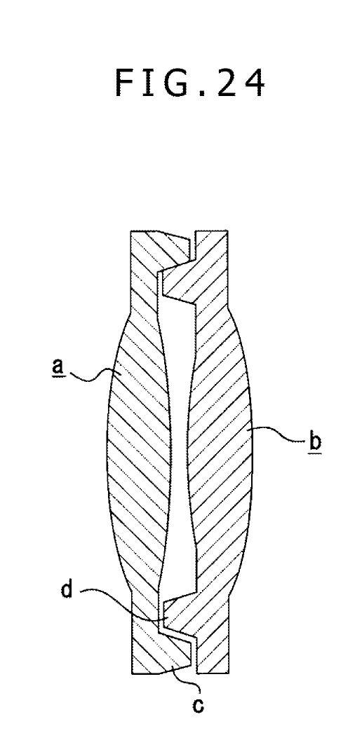

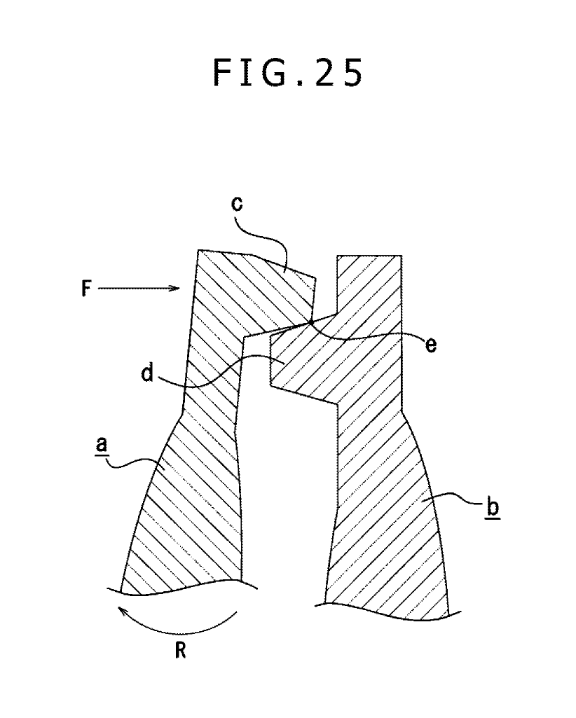

As shown in FIG. 23, the lens 30E is molded by using a mold 90. The mold 90 is composed of a first mold 91 and a second mold 92.

The first mold 91 has a central mold 91a located centrally and a peripheral mold 91b located around the periphery of the central mold 91a. Similarly, the second mold 92 has a central mold 92a located centrally and a peripheral mold 92b located around the periphery of the central mold 92a.

The lens 30E is molded by filling a lens material into a cavity 93 defined by matching the first mold 91 and the second mold 92. Of the object-side surface of the lens 30E, the optical surface 31a, a portion of the first surface 32a except its outer circumferential portion, and all the surfaces of the positioning projection 34 are formed by the central mold 91a, and the outer circumferential portion of the first surface 32a is formed by the peripheral mold 91b. Further, of the image-side surface of the lens 30E and the outer circumferential surface 32c, the optical surface 31b, a portion of the second surface 32b except its outer circumferential portion, and all the surfaces of the positioning projection 34 are formed by the central mold 92a, and the outer circumferential portion of the second surface 32b and the outer circumferential surface 32c are formed by the peripheral mold 92b. The outer circumferential surface 32c may be formed by the peripheral mold 91b or by both the peripheral mold 91b and the peripheral mold 92b.

Accordingly, the optical surface 31a and all the surfaces of the positioning projection 34 formed on the object side are formed by the central mold 91a, i.e., by the same mold. Further, the optical surface 31b and all the surfaces of the positioning projection 34 formed on the image side are formed by the central mold 92a, i.e., by the same mold.

While the positioning recess 33 and the positioning projection 34 in the lenses 30, 30D, and 30E have a trapezoidal cross section, each of the lenses 30, 30D, and 30E may have the positioning projection 13A, 13B, or 13C and the positioning recess 23A, 23B, or 23C having a triangular, U-shaped, or free-form surface cross section as shown in FIGS. 9, 10, and 11 in place of the positioning projection 33 and the positioning recess 34.

Further, the shape of the positioning recess 33 and the positioning projection 34 is not limited to an annular shape, but a plurality of positioning recesses may be formed at intervals in the circumferential direction as shown in FIG. 15 and a plurality of positioning projections may be formed at intervals in the circumferential direction as shown in FIG. 13. Further, the positioning recess 33 may have an arcuate shape as shown in FIG. 16 and the positioning projection 34 may have an arcuate shape as shown in FIG. 14.

### [Summary 2]

Also in the condition where the lens 10, the lens 30 (including the lenses 30D and 30E, the same applying to the following), and the lens 20 are positioned, there is no clearance between the positioning projection 13 and the positioning recess 33 and between the positioning projection 34 and the positioning recess 23 as similar to the case that the lens 10 and the lens 20 are positioned.

Accordingly, the positioning accuracy of the lenses 10, 30, and 20 can be improved and the optical axes of the lenses 10, 30, and 20 can therefore be made to coincide with each other with high accuracy.

Further, there is no possibility that one of the lenses 10, 30, and 20 is inclined with respect to the others about a contact point between the positioning projection 13 and the positioning recess 33 or a contact point between the positioning projection 34 and the positioning recess 23, thereby preventing the inclination of the optical axis. Accordingly, the positioning accuracy of the lenses 10, 30, and 20 can be further improved.

In the case that the positioning projections 13 and 34 and the positioning recesses 33 and 23 as the positioning engagement portions have an annular shape, the moldability of the lenses 10, 30, and 20 can be improved and the workability can be improved because alignment in the circumferential direction is not required in positioning the lenses 10, 30, and 20.

Further, the sectional shape of the positioning projections 13 and 34 along the optical axis is a shape such that the width is decreased with an increase in height in the axial direction. Accordingly, the positioning projections 13 and 34 can be easily inserted into the positioning recesses 33 and 23, respectively, thereby improving the workability in positioning the lenses 10, 30, and 20.

The opening space of the positioning recesses 33 and 23 along the optical axis is increased with a decrease in depth in the axial direction. Accordingly, the positioning projections 13 and 34 can be easily inserted into the positioning recesses 33 and 23, respectively, thereby improving the workability in positioning the lenses 10, 30, and 20.

In addition, the optical surface 31a and all the surfaces of he positioning recess 33 or the positioning projection 34 of the lens 30, 30D, or 30E are formed by the central mold 71a, 81a, or 91a, i.e., by the same mold. Similarly, the optical surface 31b and all the surfaces of the positioning projection 34 or the positioning recess 33 of the lens 30, 30D, or 30E are formed by the central mold 72a, 82a, or 92a, i.e., by the same mold.

Accordingly, the positional accuracy of the optical lens portion 31 and the positioning recess 33 and the positional accuracy of the optical lens portion 31 and the positioning projection 34 in the lens 30, 30D, or 30E can be improved, thereby improving the positioning accuracy of the lenses 10, 30 (30D or 30E), and 20.

### [Present Technology]

The present technology may have the following configurations.

(1) A lens unit including a plurality of lenses arranged along their optical axes determining an axial direction; both sides of each lens in the axial direction being formed as optical surfaces, each lens including an optical lens portion for transmitting an incident effective light flux toward an imaging surface and a flange portion formed so as to continue to the outer circumference of the optical lens portion; the flange portion of each lens being formed with a positioning engagement portion for positioning any adjacent ones of the plurality of lenses by engagement; the positioning engagement portion of one of the adjacent lenses being formed as a positioning projection projecting in the axial direction; the positioning engagement portion of the other of the adjacent lenses being formed as a positioning recess opening in the axial direction so as to engage with the positioning projection.

(2) The lens unit as defined in paragraph (1), wherein the plurality of lenses are at least three lenses arranged along their optical axes; the positioning engagement portion being formed on both sides of the flange portion in the axial direction of a central one of any arbitrary three lenses adjacent to each other; the positioning engagement portion formed on both sides of the central lens being composed of the positioning projection and the positioning recess.

(3) The lens unit as defined in paragraph (1) or (2), wherein the positioning engagement portion has an annular shape.

(4) The lens unit as defined in paragraph (1) or (2), wherein the positioning engagement portion has an arcuate shape.

(5) The lens unit as defined in paragraph (1) or (2), wherein the positioning engagement portion includes a plurality of positioning engagement portions formed at intervals in the circumferential direction of the flange portion.

(6) The lens unit as defined in any one of paragraphs (1) to (5), wherein the positioning projection has a sectional shape such that the width is decreased with an increase in height in the axial direction.

(7) The lens unit as defined in any one of paragraphs (1) to (6), wherein the positioning recess has a sectional shape such that the width is increased with a decrease in depth in the axial direction.

(8) The lens unit as defined in any one of paragraphs (1) to (7), wherein each lens is molded by using a plurality of molds; the optical surface and the positioning engagement portion present on the same side of each lens in the axial direction being formed by the same mold.

(9) An imaging apparatus including a lens unit having a plurality of lenses arranged along their optical axes determining an axial direction and an imaging device for converting an optical image taken through the lens unit into an electrical signal; both sides of each lens in the axial direction being formed as optical surfaces, each lens including an optical lens portion for transmitting an incident effective light flux toward an imaging surface and a flange portion formed so as to continue to the outer circumference of the optical lens portion; the flange portion of each lens being formed with a positioning engagement portion for positioning any adjacent ones of the plurality of lenses by engagement; the positioning engagement portion of one of the adjacent lenses being formed as a positioning projection projecting in the axial direction; the positioning engagement portion of the other of the adjacent lenses being formed as a positioning recess opening in the axial direction so as to engage with the positioning projection.

The present technology may also have the following configurations.

(1) A lens unit including at least one lens having an engagement portion in a flange portion of the lens, the engagement portion having a width perpendicular or substantially perpendicular to the optical axis of the lens, and the width of the engagement portion decreasing as the engagement portion is traversed in a direction parallel or substantially parallel to the optical axis of the lens.

(2) The lens unit according to (1), wherein the engagement portion is a projection.

(3) The lens unit according to (1), wherein the engagement portion is a recess.

(4) The lens unit according to (1), wherein the engagement portion has an annular cross-section in a plane that is perpendicular or substantially perpendicular to the optical axis of the lens.

(5) The lens unit according to (1), wherein the engagement portion has a trapezoidal cross-section in a plane that is parallel or substantially parallel to the optical axis of the lens.

(6) The lens unit according to (1), wherein the engagement portion has a triangular cross-section in a plane that is parallel or substantially parallel to the optical axis of the lens.

(7) The lens unit according to (1), wherein the engagement portion has a U-shaped cross-section in a plane that is parallel or substantially parallel to the optical axis of the lens.

(8) The lens unit according to (1), wherein the engagement portion has a free-form cross-section in a plane that is parallel or substantially parallel to the optical axis of the lens.

(9) The lens unit according to (1), wherein the lens unit includes at least two lenses, a first lens and a second lens, the first lens having an engagement portion that is a projection, and the second lens having an engagement portion that is a recess.

(10) The lens unit according to (9), wherein the projection has a trapezoidal cross-section in a plane that is parallel or substantially parallel to the optical axis of the lens, and the recess has a trapezoidal cross-section in a plane that is parallel or substantially parallel to the optical axis of the lens.

(11) The lens unit according to (9), wherein the projection has a triangular cross-section in a plane that is parallel or substantially parallel to the optical axis of the lens, and the recess has a triangular cross-section in a plane that is parallel or substantially parallel to the optical axis of the lens.

(12) The lens unit according to (9), wherein the projection has a U-shaped cross-section in a plane that is parallel or substantially parallel to the optical axis of the lens, and the recess has a U-shaped cross-section in a plane that is parallel or substantially parallel to the optical axis of the lens.

(13) The lens unit according to (9), wherein the projection has a free-form cross-section in a plane that is parallel or substantially parallel to the optical axis of the lens, and the recess has a free-form cross-section in a plane that is parallel or substantially parallel to the optical axis of the lens.

(14) The lens unit according to (9), wherein the projection has a cross-section in a plane that is parallel or substantially parallel to the optical axis of the lens that is different from a cross-section of the recess in a plane that is parallel or substantially parallel to the optical axis of the lens.

(15) The lens unit according to (1), wherein the engagement portion is located at intervals in the flange portion of the lens.

(16) The lens unit according to (1), wherein the engagement portion has an arcuate cross-section in a plane that is perpendicular or substantially perpendicular to the optical axis of the lens.

(17) The lens unit according to (1), further including a lens holder.

(18) The lens unit according to (1), wherein the lens unit includes at least three lenses, at least one of the three lenses having two engagement portions.

(19) A camera including a lens unit, wherein the lens unit includes at least one lens having an engagement portion in a flange portion of the lens, the engagement portion having a width perpendicular or substantially perpendicular to the optical axis of the lens, and the width of the engagement portion decreasing as the engagement portion is traversed in a direction parallel or substantially parallel to the optical axis of the lens.

(20) A mold including a first mold having a first central mold and a first peripheral mold; and a second mold having a second central mold and a second peripheral mold, the mold being operable to mold a lens having an engagement portion in a flange portion of the lens, wherein the engagement portion of the lens is formed by one of the first central mold and the second central mold, and wherein the engagement portion has a width perpendicular or substantially perpendicular to the optical axis of the lens, and the width of the engagement portion decreases as the engagement portion is traversed in a direction parallel or substantially parallel to the optical axis of the lens.

It should be noted that the specific shapes and structures of various parts or portions described in the above embodiments are merely illustrative and that various modifications may be made without departing from the scope of the present technology.

What is claimed is:

1. A lens unit comprising at least one lens having an engagement portion in a flange portion of the lens, the engagement portion having a width perpendicular or substantially perpendicular to the optical axis of the lens, and the width of the engagement portion decreasing as the engagement portion is traversed in a direction parallel or substantially parallel to the optical axis of the lens.

2. The lens unit according to claim 1, wherein the engagement portion is a projection.

3. The lens unit according to claim 1, wherein the engagement portion is a recess.

4. The lens unit according to claim 1, wherein the engagement portion has an annular cross-section in a plane that is perpendicular or substantially perpendicular to the optical axis of the lens.

5. The lens unit according to claim 1, wherein the engagement portion has a trapezoidal cross-section in a plane that is parallel or substantially parallel to the optical axis of the lens.

6. The lens unit according to claim 1, wherein the engagement portion has a triangular cross-section in a plane that is parallel or substantially parallel to the optical axis of the lens.

7. The lens unit according to claim 1, wherein the engagement portion has a U-shaped cross-section in a plane that is parallel or substantially parallel to the optical axis of the lens.

8. The lens unit according to claim 1, wherein the engagement portion has a free-form cross-section in a plane that is parallel or substantially parallel to the optical axis of the lens.

9. The lens unit according to claim 1, wherein the lens unit comprises at least two lenses, a first lens and a second lens, the first lens having an engagement portion that is a projection, and the second lens having an engagement portion that is a recess.

10. The lens unit according to claim 9, wherein the projection has a trapezoidal cross-section in a plane that is parallel or substantially parallel to the optical axis of the lens, and the recess has a trapezoidal cross-section in a plane that is parallel or substantially parallel to the optical axis of the lens.

11. The lens unit according to claim 9, wherein the projection has a triangular cross-section in a plane that is parallel or substantially parallel to the optical axis of the lens, and the recess has a triangular cross-section in a plane that is parallel or substantially parallel to the optical axis of the lens.

12. The lens unit according to claim 9, wherein the projection has a U-shaped cross-section in a plane that is parallel or substantially parallel to the optical axis of the lens, and the recess has a U-shaped cross-section in a plane that is parallel or substantially parallel to the optical axis of the lens.

13. The lens unit according to claim 9, wherein the projection has a free-form cross-section in a plane that is parallel or substantially parallel to the optical axis of the lens, and the recess has a free-form cross-section in a plane that is parallel or substantially parallel to the optical axis of the lens.

14. The lens unit according to claim 9, wherein the projection has a cross-section in a plane that is parallel or substantially parallel to the optical axis of the lens that is different from a cross-section of the recess in a plane that is parallel or substantially parallel to the optical axis of the lens.

15. The lens unit according to claim 1, wherein the engagement portion is located at intervals in the flange portion of the lens.

16. The lens unit according to claim 1, wherein the engagement portion has an arcuate cross-section in a plane that is perpendicular or substantially perpendicular to the optical axis of the lens.

17. The lens unit according to claim 1, further comprising a lens holder.

18. The lens unit according to claim 1, wherein the lens unit comprises at least three lenses, at least one of the three lenses having two engagement portions.

19. A camera comprising a lens unit, wherein the lens unit comprises at least one lens having an engagement portion in a flange portion of the lens, the engagement portion having a width perpendicular or substantially perpendicular to the optical axis of the lens, and the width of the engagement portion decreasing as the engagement portion is traversed in a direction parallel or substantially parallel to the optical axis of the lens.

20. A mold comprising:
a first mold having a first central mold and a first peripheral mold; and
a second mold having a second central mold and a second peripheral mold,
the mold being operable to mold a lens having an engagement portion in a flange portion of the lens, wherein the engagement portion of the lens is formed by one of the first central mold and the second central mold, and wherein the engagement portion has a width perpendicular or substantially perpendicular to the optical axis of the lens, and the width of the engagement portion decreases as the engagement portion is traversed in a direction parallel or substantially parallel to the optical axis of the lens.
